(19) United States
(12) Patent Application Publication
(10) Pub. No.: US 2019/0050783 A1
(43) Pub. Date: Feb. 14, 2019

(54) METHOD AND SYSTEM FOR CONTROLLING WORK FLOW IN CAR MAINTENANCE WORKSHOPS

(71) Applicant: ESFERA COLOR LTDA, Bogotá (CO)

(72) Inventors: Juan Manuel GUTIERREZ SANCHEZ, Bogotá (CO); Johan Agustin BAYONA CAMARGO, Bogotá (CO)

(73) Assignee: ESFERA COLOR LTDA, Bogotá (CO)

(21) Appl. No.: 15/763,728

(22) PCT Filed: May 19, 2016
(86) PCT No.: PCT/IB2016/052960

§ 371 Date: May 25, 2018

(30) Foreign Application Priority Data
Oct. 7, 2015 (CO) 15239091

(51) Int. Cl. G06Q 10/06; G01S 5/14; G06Q 10/00; G06K 7/10; H04W 4/40

(52) U.S. Cl. CPC G06Q 10/06398; G01S 5/14; H04W 4/40; G06Q 10/20; G06K 7/10297; G06Q 10/063114

(57) ABSTRACT

A system and method for automatic time tracking, more specifically, for controlling and optimizing the workflow, repair, maintenance and location of vehicles at a repair shop and/or authorized dealer, operates by calculating the proximity of the operator to the vehicle, thus optimizing the process affected by bottlenecks, fulfillment of repair processes, workload of the shop, efficiency, need for spare parts and communication with the owner of the vehicle for authorization.

### 1. FIELD OF THE INVENTION

The present invention relates to a system and method for performing real-time positioning of vehicles and operators inside repair shops and dealerships in an autonomous and highly accurate manner. The present invention also relates to an increase in productivity, graphically communicating the status of all vehicles in the shop, graphically communicating the time invested by employees, tracking time without relying on user intervention, expediting the car rental process, and making decisions about the availability and efficiency of the technician. The present invention is a hardware and software tool coupled with the authorized dealer's ERP to increase repair shop productivity through highly accurate and real-time location of operators and vehicles, as well as time tracking and effectiveness of the technician in charge.

### 2. BACKGROUND OF THE INVENTION

The prior art includes systems for highly accurate, real time tracking. These systems include antenna arrays arranged to define a portal to a detection region, systems for conducting procedures to request repairs without disturbing the driver when a car breaks down, a system for detecting intruders near or inside a vehicle, a system for determining a near field communication interaction in a wireless, tracking mesh network, among other.

The prior art also includes tracking methods using real-time locating systems (RTLS). These methods include a wireless tag and control module, wherein the wireless tag is operable to transmit distance signals wherein each distance signal indicates a distance between the wireless tag and an associated access point, and wherein the distance of the tag is based on a strength of a wireless signal from the associated access point received by the tag, methods to detect and identify an operator near or inside a vehicle as an authorized or unauthorized user, and an improved short-range wireless communication methods, among other.

Based on the literature review of different scientific sources, it was found that there are systems and methods for using a short-range wireless communication between an on-board device mounted on a vehicle and an external object such as a fixed station. Thus, there is a large number of patents aimed at the technical improvement of real-time positioning systems from communication in a confined space. The main characteristics and their most significant differences are presented next. Let's see:

Patent application US2002158760 describes a wireless communication method which uses an on-board apparatus communicating with the outside in a short-range wireless communication system. Accordingly, the subject matter of the invention is to provide an improved short-range wireless communication method. The main difference with the present application is that said document does not teach implementation for dealers or repair shops where employees clock in their work hours or the graphic, real-time representation of the vehicle and the operators. Instead, it comprises an on-board apparatus having a screen and interface inside the vehicle for communication with the user.

Patent application US2002044096 describes an antenna array comprising a plurality of antenna loops arranged to define a portal or step or another detection region in which the antenna loops transmit and/or receive electromagnetic signals. The main difference with the present application is that said document does not teach the vehicle check in at the repair shop or the inclusion of the reading device, or the identification of the vehicle with wireless reference or recording of working times. It does not mention implementation in repair shops and/or authorized dealers.

Patent application US2002193926 describes a system for carrying out procedures for requesting repair work without disturbing the driver when a car breaks down, as well as different on-board peripheral devices and the cell phone used for this system. This system comprises an on-board peripheral device with a fault detector, a main on-board controller of the car's information management, a mobile phone, what the wireless connection can do with the main on-board controller, and a response center for receiving auto repair and maintenance requests and making arrangements for it. The main difference with the present application is that said document does not teach the vehicle check in at the repair shop or the inclusion of the reading device, or the recording of working times. It also does not use real-time positioning inside authorized dealers and it does not describe the graphic representation of the vehicle and the operators.

Patent application US2014306799 describes a method and system for detecting an intruder near or inside a vehicle. Specifically, it describes a method for detecting and identifying a fence or inside a vehicle as an authorized or unauthorized user. The main difference with the present application is that said document does not teach virtual communication through an App with the owner of the vehicle, it does not specify time tracking or record work orders.

Patent application US2011316695 describes systems and methods of monitoring and managing hygiene using a real-time location (RTLS). Furthermore, the invention describes RTLS systems used to supervise and manage the cleaning of rooms and surfaces, and the location of cleaning items and cleaning staff. The invention provides an improved efficiency and quality of hygiene services. The invention allows prioritization of cleaning, improves the efficient use of cleaning items and cleaning staff, the monitoring of short- and long-term cleaning operations, and gives an idea of ineffective cleaning. The system and method includes a wireless tag and a control module. The main difference with the present application is that said document does not teach the vehicle check in at the repair shop or the inclusion of the reading device; it also does not mention its implementation in authorized dealers or repair shops where the employee records his working times. It also does not specify the graphic representation of the vehicle.

Patent application US2011068892 describes a method and a system for determining a near field communication interaction in a wireless tracking mesh network. It also preferably uses near field communication devices, together with tracker tags to transmit signals for reception by the sensors placed along an installation forming a mesh network and transmitting the signals to an information engine for analysis. The main difference with the present application is that said document does not teach implementation in authorized dealers or repair shops where the employee records his working times. It also does not describe an application for communicating with the customer through a mobile app, and it does not use the information gathered in the analysis and improvement of productivity.

It is particularly worth mentioning that none of the above-mentioned prior art documents report experimental results that demonstrate the effect of incorporating these system configurations in the use of automatic time-tracking for applications in the optimization of process times and the communication of process progress with the client. Accordingly, this application has the advantage of positioning operators and vehicles by means of a tag and antennas. The device is also highly accurate, delivering the position data wirelessly to a server containing a localization engine and a position acquisition database. This optimization and bottleneck reduction in information management is achieved through proprietary algorithms and complemented with an app for a mobile device that communicates with the customer.

### 3. GENERAL DESCRIPTION OF THE INVENTION

In accordance with the problems identified in the prior art, this application provides a system and a method for automatic time tracking by calculating the proximity of the operator to the vehicle and with algorithms that determine the relevance of the tracking. The present invention further aims to increase the overall productivity in a repair process at an authorized dealer by focusing on improving the cause of the bottleneck. A device for monitoring, automatic tracking, real-time optimization was designed, as well as a complete system to analyze the information and to communicate with the owner of the vehicle.

Specifically, this application provides a method for positioning of operators and vehicles by means of wireless communication consisting in the steps of:
Assigning a device to each operator.
Reception of the vehicle at the repair shop and inclusion of the reading device.
Monitoring of the vehicles and operators with wireless reference.
Location algorithms and engine.
Compilation of proximity data and work times.
Real-time graphic representation of the vehicle and operators.
Bidirectional communication with the owner of the vehicle.

Accordingly, the present invention illustrates a novel system and method by which an automatic time tracking system with the calculation of the proximity of the operator to the vehicle seeks to solve the current shortcomings in repair shops for measuring real work times in vehicles without relying on the operator's willingness to do the tracking.

### 4. BRIEF DESCRIPTION OF THE FIGURES

FIG. 1: Shows the configuration by triangulation.

FIG. 2: Shows the configuration by RFID tag mesh on the floor.

FIG. 3: Shows the location of tags in the operator and in the vehicle.

FIG. 4: Shows time tracking according to proximity and assignment.

### 5. DETAILED DESCRIPTION OF THE INVENTION

The present invention relates to a system and a method for autonomous and highly precise real-time positioning of vehicles and operators inside repair shops and authorized dealers. Through positioning algorithms, this information is used for conducting automatic time tracking and it analyzes the information for managing and optimizing processes, all with constant communication with the client.

### 5.1. Positioning Systems

The system consisting of hardware (tags and antennas) and software (location engine) gathers the information acquired by the sensors and devices to identify the position of the operators or vehicles with respect to the layout of a specific dealer, with a low energy consumption and high accuracy in the location, for which two methods have been developed.

### 5.1.1. Triangulation

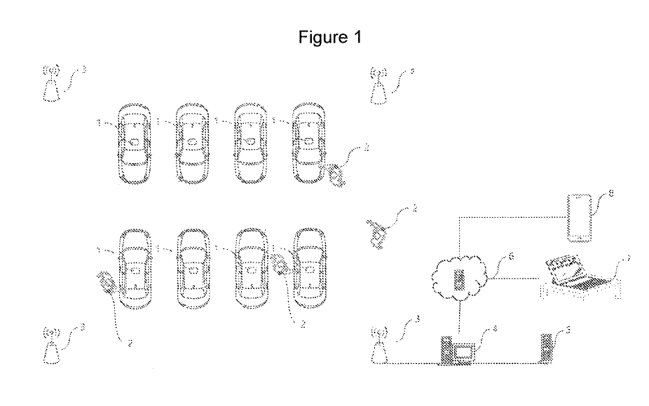

This method consists of placing tags in the vehicles and operators, which communicate wirelessly with at least three antennas to determine their distance from each one of them; at the same time, those antennas send the information gathered to a server, where the location engine does trilateration algorithms to determine the position in coordinates of each of the tags (vehicles or operators) inside the dealership, which are then stored in the positioning database and analyzed to determine the pertinence of the operator's time tracking on the vehicle, thus avoiding false or erroneous tracking. FIG. 1 shows a schematic view of the configuration by triangulation, where the tag device (1) is located in the vehicle, the tag device (2) is located in the operator, the antennas (3) are located in spatially distributed points for a correct triangulation. The server of the dealer (4) communicates with the ERP (5) of the repair shop, the central server (6), the interface for employees (7) of the repair shop, and the interface for the owners (8) of the vehicles.

### 5.1.2. Tag Mesh on the Floor

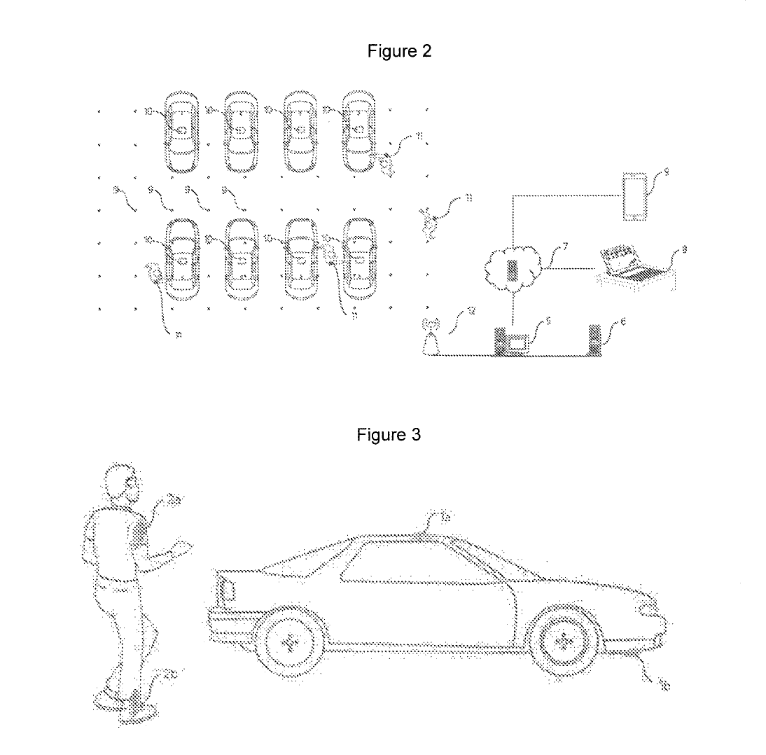

This method consists of a tag mesh on the floor that stores the position in coordinates of each tag in a microchip. When the reading device comes closer within a parameterized range, it reads said information and transmits it wirelessly to the Access Points, which gather the information from all devices and transmit it to the server to be analyzed by the Data Acquisition service and subsequently stored in the positioning database. FIG. 2 shows a schematic view of the mesh configuration, wherein the RFID Tag Mesh (9) is located on the floor, the reading device (10) is located in the vehicle, and the reading device (11) is located in the operator. The Access Points (12) are the means of communication with the Server of the Dealer (4) at the repair shop, the ERP (5) of the repair shop, the central server (6), the interface for employees (7) of the repair shop, and the interface for the owners (8) of the vehicles.

### 5.1.3. Positioning by Mobile Phone and Other Technology

Mobile phone technology nowadays is not capable of doing positioning with the accuracy required for some types of applications, particularly in indoor applications. Accordingly, the architecture of the present application allows switching between positioning technologies and is ready when mobile phones are highly accurate in indoor and outdoor environments.

The market offers different types of real-time positioning technologies, including:
Active radio frequency identification (Active RFID)
Active radio frequency identification-infrared hybrid (Active RFID-IR) Infrared (IR)
Second Generation Infrared (Gen2IR™)
Optical locating
Low-frequency signpost identification
Semi-active radio frequency identification (semi-active RFID)
Passive RFID RTLS locating via Steerable Phased Array Antennae
Radio beacon
Ultrasound Identification (US-ID)
Ultrasonic ranging (US-RTLS)
Ultra-wideband (UWB)
Wide-over-narrow band
Wireless Local Area Network (WLAN, Wi-Fi)
Bluetooth
Clustering in noisy ambience
Bivalent Systems
Augmented Reality (AR)

### 5.2. Operation Details

FIG. 3 shows the location of tags in the operator and in the vehicle. The tag device (1a) is located in the vehicle for positioning the tag device for configuration by triangulation. The device (1b) is located in the vehicle for positioning the reader device for configuration by tag mesh on the floor. The tag device (2a) is located in the operator for positioning the tag device for configuration by triangulation. The device (2b) is located in the operator for positioning the reader device for configuration by tag mesh on the floor.

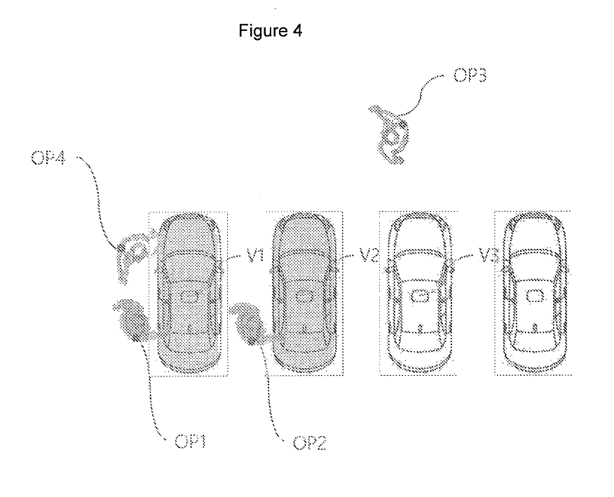

FIG. 4 shows a schematic view for time tracking by proximity and assignment. This figure shows vehicle 1 (V1) assigned to operator 1 (OP1), vehicle 2 (V2) assigned to operator 2 (OP2), vehicle 3 (V3) assigned to operator 3 (OP3), vehicle 4 (V4) assigned to operator 4 (OP4) for work assignment. The figure also shows time tracking, wherein vehicle 1 (V1) is tracking time (proximity with operator 1), vehicle 2 (V2) is tracking time (proximity with operator 2), vehicle 3 (V3) is not tracking time (operator 3 is out of proximity range) and vehicle 4 (V4) is not tracking time (operator 4 is out of proximity range). It further shows operator 1 (OP1) tracking time (proximity to vehicle 1), operator 2 (OP2) tracking time (proximity to vehicle 2), operator 3 (OP3) not tracking time (out of range of vehicle 3), and operator 4 (OP4) not tracking time (vehicle 1 is not assigned and is out of range of vehicle 4).

### 5.3. Method for Monitoring Workflow on a Vehicle

The present invention describes a method for monitoring the flow of work done on vehicles inside repair shops and authorized dealers in an autonomous and highly accurate manner, method characterized by comprising the steps of:
Automatically reminding the owner of the vehicle when he or she must perform preventive maintenance and update legal matters;
Assisting the owner of the vehicle when he or she in case of collision with recommendations, quotations, selection of the repair shop, and scheduling appointments;
Assigning a wireless device to operators;
Checking in the vehicle and recording evidence of details of the repair and vehicle;
Assigning a wireless device to the vehicle;
Automatically assigning the vehicle to one or more operators through critical path algorithms;
Starting operator and vehicle monitoring through RTLS technologies;
Tracking operator and vehicle times through proximity algorithms, work assignment, duration of stay in the area and other algorithms to define whether the operator is actually working on the vehicle;
Informing employees at the repair shop about the status of the vehicle and
possible ways to improve productivity;
Informing the owner of the vehicle about the current status and process of the vehicle at the shop;
Allowing the shop to send additional quotations to the owner of the vehicle through the vehicle owner interface (8);
Allowing the owner of the vehicle to authorize additional quotations through the vehicle owner interface (8);
Ending the process of the vehicle at the shop and de-assigning wireless device;
Informing the shop about the vehicle's profitability, including materials, labor and cost of the duration of stay; and
Allowing the owner of the shop to conduct productivity analysis to make decisions that help to improve profitability.

Based on the data gathered by the system for positioning, the tracking algorithms under pre-configured parameters determine when an operator is working on a vehicle that has been assigned to him, making sure the time tracking is recorded when the operator is actually working on the vehicle.

5.2.1. The Graphic Interface that Enables the Following Operations:
a) Interconnectivity: To avoid double entry and keep a single information site, we developed interconnectivity with the ERP of the repair shops, such that we obtain information about Work Orders, Employees and other types of information relevant to the application.
b) Work order: In the work order you can check all the vehicle's information relevant to the operation of the repair shop. The license plate number, pictures, videos, insurance company, client, telephone numbers, pending spare parts, authorized work, etc. The Work Order information are entered on the Tablet in the repair shop's ERP through a service provided by the ERP. Therefore, the use of printed car check-in forms is eliminated.
c) Photo & video: Currently, when a repair shop checks a vehicle in, they take pictures and videos as evidence of the state of the car when it comes in. This is done with a camera, and the information is subsequently downloaded to a desktop computer. Pictures are taken on the tablet and automatically loaded to the server to avoid the manual downloading process.
d) RTLS: Allows real-time location of vehicles and operators.
e) Graphic notifications: A notification system is available to inform the user when a vehicle is being delayed or there are any pending issues, such as with spare parts, authorizations, etc.
f) Graphic record of movements: A feature that shows what is going on at the shop during a specific time, with the possibility of speeding up or slowing down the video.
g) Analysis of bottlenecks: Analysis of bottlenecks is very representative of the productivity of the repair shop because it determines at what point of the process vehicles are being delayed. The graphics show the bottleneck analysis performed for car dealers. Every dealership has the opportunity to improve its overall productivity by focusing its efforts on the auto body repair and paint processes. Similarly, each dealership has the opportunity to improve its overall productivity by focusing its efforts on the insurer and spare parts authorization processes. The shops often focus their efforts at the end of the process because the delivery of the vehicle to the final customer is approaching. Furthermore, bottlenecks are dynamic, and therefore they can move in time. Shops must have tools to determine and graphically report where the restriction is, so that they can focus on the processes that are causing the problem.
h) Work schedule: A quick look shows the status of each vehicle according to a previously established work schedule.
i) Shop load: A quick look shows the work load of each operator according to position. This information is important to be able to assign new jobs to operators.
j) Operator efficiency: This report shows which operators are performing below the expected efficiency.
k) Spare parts pending: Through interconnectivity with the shop's ERP, it shows the spare parts pending delivery to start the repair work. It includes the date on which the order for the spare part was placed and the status of the order.

### EXAMPLES

### Example 1

The following graphic shows the differences and advantages of this invention as compared to the prior art:

| | | INTER | | | | | | | |
|---|---|---|---|---|---|---|---|---|---|
| | | CONNECTIVITY | | | | | | | Repair shop |
| | | Coupling with ERP | | Viewport and registration tools | | | | | management |
| | | (Avoids double entry | RTLS | | | | | Photos and | analysis tools |
| | | of information and | Real-time | Viewport with | | | Operations | Videos from | Graphic |
| Type of | Available | Does not require | location | repair shop | Automatic | Work Orders | and sub- | the Tablet to | filters in |
| Solution | solutions | change of ERP | (RTLS) | layout | timing | Module | operations | the server | the viewport |
| SysTime | SysTime | Yes | Yes | | Yes | Yes | Yes | Yes | Yes (in |
| | | | | | | | | | development) |
| RLTS | RLTS | Needed to be | Yes | | No | No | No | No | No |
| systems | systems | developed | | | | | | | |
| | (Active | | | | | | | | |
| | RFID, | | | | | | | | |
| | Passive | | | | | | | | |
| | RFID, Tags | | | | | | | | |
| | on the floor, | | | | | | | | |
| | Augmented | | | | | | | | |
| | Reality . . .) | | | | | | | | |
| ERP | ERP Spiga, | No | No | | Manual | No | No | Some | No |
| systems | Quiter, DMS, | | | | tracking | | | | |
| | Max Traxx, | | | | | | | | |
| | Audatex | | | | | | | | |
| Expert | Sipo - Cesvi | No | No | | No | No | Yes | No | No |
| report | | | | | | | | | |
| Apps | My Car, Mi | Some | No | | No | No | No | No | No |
| | Carro, | | | | | | | | |
| | CarManager, | | | | | | | | |
| | Carminder, | | | | | | | | |
| | Carendar | | | | | | | | |

| | | | | Communication | | | |
|---|---|---|---|---|---|---|---|
| | | | | with the owner | | | |
| | Repair shop management | | | of the vehicle | Spare parts | | |
| | analysis tools | | | Quotations from | Quotations from | | |
| | | | Permanence | the repair shop | the cell phone of | | Expert report |
| Type of | | Bottlenecks | times (dynamic | to the cell phone | the vehicle owner | Spare parts | Virtual expert |
| Solution | Re-play | in real-time | graph) | of the vehicle owner | to the repair shop | management | report |
| SysTime | Yes (in | Yes | Yes | Yes | Yes | To be | To be |
| | development) | | | | | developed | developed |
| RLTS | No | No | No | No | No | No | No |
| systems | | | | | | | |
| ERP | No | No | Some | No | No | Yes | No |
| systems | | | | | | | |
| Expert | No | No | No | No | No | — | No |
| report | | | | | | | |
| Apps | No | No | No | Some | No | No | No |

### Example 2

In a car dealer network, the current location of operators and vehicles inside the dealer generates an automatic time tracking without human intervention, identifying the proper actions in real time to improve times and processes. This information, centralized and available for the entire network, allows the optimization of processes and improvement in productivity, with constant communication with vehicle owner customers, improving feedback and having the information and communication available with the customer at all times, to cross-sell between other activities.

### Example 3

In another example, in a chain store network, by knowing the customer's location at all times and in real time and knowing how long they spend on searching, identifying and acquiring products, you can make the right decision to find better ways to reach customers, the right products and with a better turnover, and even the behavior of the market and sectors on which they are focused, as well as the behavior and productivity of their employees.

### Example 4

In the field of aviation, it is necessary to track the time invested by technicians in the maintenance of aircrafts in order to generate plans to improve productivity and the notification of the progress of maintenance or repair works.

### Example 5

In the automotive sector, more specifically in companies that import vehicles and which have very large parking lots with parked vehicles, they sometimes take up to half a day to locate a vehicle, because it is not easy to determine the location of the vehicles in the parking lots. This invention allows importers to know the exact position of each vehicle, such that locating it is a very quick and easy task.

### Example 6

For marketing companies with a sales force, the present invention allows tracking the sales force to determine for how long the seller was in the proximity of a customer, how much time he spent moving how much time he spent at the office and how much time is spent in other activities.

### Example 7

The present invention enables control of the location of gas cylinders on loan at hospitals to keep them from being stolen or lost. It allows you to know when a cylinder is being moved by someone who has not been authorized by the company to do so.

Gas companies currently have serious problems managing this type of assets, which are scattered all over the country.

1. A method for monitoring the flow of work done on vehicles inside repair shops and authorized dealers in an autonomous and highly accurate manner, method comprising the steps of:
automatically reminding the owner of the vehicle when he or she must perform preventive maintenance and update legal matters;
assisting the owner of the vehicle when he or she in case of collision with recommendations, quotations, selection of the repair shop, and scheduling appointments;
assigning a wireless device to operators;
checking in the vehicle and recording evidence of details of the repair and vehicle;
assigning a wireless device to the vehicle;
automatically assigning the vehicle to one or more operators through critical path algorithms;
starting operator and vehicle monitoring through RTLS technologies; tracking operator and vehicle times through proximity algorithms, work assignment, duration of stay in the area and other algorithms to define whether the operator is actually working on the vehicle;
informing employees at the repair shop about the status of the vehicle and possible ways to improve productivity;
informing the owner of the vehicle about the current status and process of the vehicle at the shop;
allowing the shop to send additional quotations to the owner of the vehicle through the vehicle owner interface;
allowing the owner of the vehicle to authorize additional quotations through the vehicle owner interface;
ending the process of the vehicle at the shop and de-assigning the wireless device;
informing the shop about the vehicle's profitability, including materials, labor and cost of the duration of stay; and
allowing the owner of the shop to conduct productivity analysis to make decisions that help to improve profitability.

2. The method according to claim 1, wherein the element to be monitored is checked in and recorded with photographs and video.

3. The method according to claim 2, wherein the vehicle processing parameters are received.

4. The method according to claim 1, wherein the vehicle is checked in, assigned, and at least one wireless device is placed in the vehicle.

5. The method according to claim 4, wherein the wireless device is placed inside the vehicle.

6. The method according to claim 4, wherein the wireless device is placed outside the vehicle.

7. The method according to claim 1, wherein during the triangulation, at least three antennas are connected, making up a trilateral coordinate.

8. The method according to claim 1, wherein during the triangulation, the information gathered is sent to the location engine.

9. The method according to claim 1, wherein the tag identifies the reading device when it enters the parameterized range.

10. The method according to claim 1, characterized wherein the tag transmits the information wirelessly to the access points.

11. The method according to claim 1, wherein in the mesh, the information is sent from the access points to a collector of processing parameters.

12. The method according to claim 1, wherein the vehicle and the operator are monitored through pairing of processing parameters.

13. The method according to claim 1, wherein the vehicle and the operator are monitored through assigning of photographs.

14. The method according to claim 1, wherein the vehicle and the operator are monitored in real time through the interconnectivity of wireless signals, including such as Active radio frequency identification (Active RFID), Active radio frequency identification infrared hybrid (Active RFID-IR), Infrared (IR), Second Generation Infrared, Optical locating, Low-frequency signpost identification, Semi-active radio frequency identification (semi-active RFID), Passive RFID RTLS locating via Steerable Phased Array Antennae, Radio beacon, Ultrasound Identification (US-ID), Ultrasonic ranging (US-RTLS), Ultra-wideband (UWB), Wide-over-narrow band, Wireless Local Area Network (WLAN, Wi-Fi), Bluetooth, Clustering in noisy ambience, Bivalent Systems, Augmented Reality (AR), Wi-Fi (WPS), Bluetooth, GSM, GPS, and Infrared.

15. The method according to claim 1, wherein the vehicle and the operator are monitored through interconnectivity with the ERP from the dealerships.

16. The method according to claim 1, wherein the vehicle and the operator are monitored through dynamic reports of work times.

17. The method according to claim 1, wherein the vehicle and the operator are monitored through dynamic reports of bottlenecks.

18. The method according to claim 1, wherein the vehicle and the operator are monitored through dynamic reports of repair shop workloads.

19. The method according to claim 1, wherein the vehicle and the operator are monitored through dynamic reports of operator efficiency.

20. The method according to claim 1, wherein the vehicle and the operator are monitored through dynamic reports of pending spare parts.

21. A system for determining the flow of work done on vehicles in repair shops and authorized dealers in an autonomous and highly accurate manner, comprising:
i) A wireless communication device comprising:
a. An RFID radio frequency identifier;
b. Access point network switch;
c. Tag reader;
d. Antennas
e. Tag reader;
f. Server with location engine.
ii) One or more tags for identification of the vehicle and operator;
iii) A data processing device for determining the workload of an operator, work times, bottlenecks, dynamic reports on repair shop workloads, operator efficiency and pending spare parts; and
iv) A data processing device for notifying the customer about the status of the vehicle.

22. The system according to claim 21, wherein the device comprises an RFID tag or transponder.

23. The system according to claim 21, wherein the device comprises an RFID tag in the tags.

24. The system according to claim 21, wherein the device comprises an active RFID tag.

25. The system according to claim 21, wherein the device comprises a passive RFID tag.

26. The system according to claim 21, wherein the device comprises a semi-passive RFID tag.

27. The system according to claim 21, wherein the device comprises an RFID reader or transceiver.

28. The system according to claim 21, wherein the device comprises a communication frequency in the range of 868 MHz to 5.2 GHz.

29. The system according to claim 21, wherein the device comprises the GSM mobile phone communication frequency.

30. The system according to claim 21, wherein the device comprises at least one access point network switch.

31. The system according to claim 21, wherein the device comprises at least one tag reader.

32. The system according to claim 21, wherein the device comprises a location engine comprising a microprocessor.
